(19) United States
(12) Patent Application Publication
(10) Pub. No.: US 2004/0145656 A1
(43) Pub. Date: Jul. 29, 2004

(54) Atlas including at least one video sequence

(75) Inventor: Gisele Betra, Asnieres (FR)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: L'Oreal, Paris (FR)

(21) Appl. No.: 10/614,753

(22) Filed: Jul. 8, 2003

Related U.S. Application Data
(60) Provisional application No. 60/395,622, filed on Jul. 15, 2002.

(30) Foreign Application Priority Data
Jul. 9, 2002 (FR) 02 08614

(51) Int. Cl. G06F 17/60; H04N 7/18

(52) U.S. Cl. 348/77; 705/16; 382/128

(57) ABSTRACT

The present invention relates to an atlas comprising a plurality of images corresponding to different grades of at least one characteristic of body typology and at least one video sequence associated with at least one of the images of the atlas, said sequence comprising images expressing said characteristic.

### CROSS REFERENCE TO RELATED APPLICATIONS

The present application claims the benefit of French patent application number 02-08614, filed Jul. 9, 2002 and U.S. provisional patent application No. 60/395,622, filed Jul. 15, 2002, the disclosures of which are hereby incorporated by reference.

The present invention relates to evaluating characteristics of body typology, and in particular to evaluating healthy or unhealthy, capillary or cutaneous states.

In the meaning of the present application, the term “characteristics of body typology” is used to cover characteristics that are mechanical, morphological, or physiological.

### BACKGROUND OF THE INVENTION

In order to evaluate the nature of a person's skin, it is known to compare an image of the skin with images in an atlas, the images corresponding to respective different kinds of skin, for example skin that is more or less dry or greasy.

Such evaluation can be useful at a point of sale, for example, in order to prescribe a treatment.

Comparing an image of the skin whose state is to be evaluated with the images in the atlas can be difficult, in particular for an unpracticed person.

### OBJECTS AND SUMMARY OF THE INVENTION

Consequently, there exists a need to benefit from an improved atlas making it possible in particular to evaluate more precisely and/or more reliably a characteristic of body typology, for example a cutaneous state or a capillary state.

In one of its aspects, the invention makes it possible specifically to satisfy this need by means of an atlas which may comprise a plurality of images corresponding respectively to different grades of at least one characteristic of body typology, and at least one video sequence associated with at least one of the images in the atlas, said sequence comprising images that express said characteristic.

Viewing the video sequence can make it easier for the observer to confirm the selection of an image from the atlas.

It turns out to be easier to identify certain characteristics of the image acquired by the camera from within a video sequence than by making comparisons with images in the atlas.

In addition, the image acquired by the camera may be an image which is frozen on the screen after moving the camera over the zone to be evaluated.

The image sequence which appears on the screen during this movement can resemble to a greater or lesser extent the video sequence which is associated with the selected image in the atlas and can reassure the operator concerning image selection.

When evaluating capillary state, viewing a video sequence also makes it possible to take account of the fact that it is not generally possible on a screen to view a magnified view of an entire hair if the hair is long. Thus, the video sequence can make it possible to view the state of a hair starting from its root and going all the way to its tip, and thus making it possible to evaluate more precisely the state of the hair as a function of its appearance at different locations.

Finally, where appropriate, viewing a video sequence makes it possible for the person under evaluation to understand better what is it that characterizes a capillary state or a cutaneous state, for example.

The images in the atlas may be electronic images capable of being displayed on a screen, simultaneously or otherwise.

All of the images in the atlas may thus be displayed simultaneously on a screen in a particular implementation of the invention. In a variant, only a fraction of the images in the atlas can be displayed on one screen. Thus, for example, the screen may be capable of displaying only a single image from the atlas at one time, and the atlas may be configured for example in such a manner that acting on a cursor enables the displayed image to be replaced by another image from the atlas, each image from the atlas that is not displayed on the screen possibly being stored in compressed form, for example, in an electronic memory or on a computer medium such as a hard disk or an optical disk, for example. The images of the atlas may be downloaded from a remote server over a wired or other connection.

The images of the atlas may all be images acquired by means of a camera for taking still or moving pictures, or alternatively at least a fraction of the images may be generated by morphing from images that have been acquired by means of a camera for taking still or moving pictures.

The atlas may include action buttons associated with respective different images in the atlas, which buttons on being actuated, e.g. by means of a pointer such as a computer mouse, serve to cause the corresponding video sequence to be displayed. The action buttons may be constituted by the images in the atlas themselves.

By way of example, the video sequence may be recorded on a computer medium or it may be downloaded, e.g. after making a connection to a streaming server.

The atlas may also include at least one audio sequence associated with the video sequence.

In another of its aspects, the invention provides image acquisition apparatus comprising:

at least one camera enabling an image to be acquired;

at least one screen enabling at least one image acquired by the camera to be displayed, preferably in association with at least one image of an atlas comprising a plurality of images expressing respective different grades of a characteristic of body typology; and

processor means enabling at least one video sequence associated with at least one of the images of the atlas to be displayed on the screen, said sequence comprising images expressing said characteristic.

The processor means may comprise a microcomputer such as a portable personal computer (PC), for example, or it may comprise a special purpose electronic apparatus.

The processor means may comprise, for example, a microcomputer which is present on the premises where the image is acquired, or which is remote, in which case the acquired image is transmitted to the processor means, e.g. over the Internet, via a connection that may be wired or wireless.

The processor means may comprise a plurality of processor units that are geographically remote from one another.

Specifically, the processor means may comprise a first microcomputer on the site where an image is acquired for comparison with the images of the atlas, and at least one second computer connected via a computer connection to the first microcomputer, data processing being performed at least in part in each computer.

The camera may have a magnifying lens, in particular providing magnification by a factor equal to or greater than 20 or 160, for example. For observing the skin, the magnification factor may be equal to about 30, for example, while for observing hairs, it may be equal to about 200.

The camera may include at least one pushbutton and the apparatus may be configured to freeze on the screen an image filmed by the camera when the pushbutton is depressed. Thus, an operator can move the camera over the skin or the hair of the person under examination until a zone is found that makes it possible to achieve as accurate as possible an evaluation of the state of the skin or the hair.

The image frozen on the screen may then be compared with the images of the atlas in order to make it easy to select which one is closest.

The duration of at least one video sequence may be greater than or equal to 5 seconds (s), for example equal to or greater than 10 s, e.g. equal to about 13 s.

The apparatus may include means for enabling an observer to interrupt at any moment the playback of a video sequence. For example, acting on a key of a keyboard or on an action button, e.g. an icon present on the screen, while the video sequence is running can cause the sequence to stop and return to the screen having the image coming from the camera together with one or more images of the atlas.

The camera may include integrated lighting means.

The apparatus may include a printer.

The processor means may be configured in such a manner that the images of the video sequence are displayed at a size that is substantially equal to the size of the image displayed on the screen and coming from the camera.

The apparatus may be configured in such a manner that the images of the sequence are displayed in association with an image coming from the camera, in particular a frozen image.

The apparatus may further include a sensor suitable for measuring at least one color or other magnitude. The sensor may be constituted, for example, by a melanometer suitable for measuring skin pigmentation.

The processor means may be configured to establish a diagnosis on the basis of at least one selected image of the atlas. Treatment or care products may then be prescribed in order to treat the skin or the hair. The diagnosis may be renewed after treatment or after a predetermined duration in order to observe any modification, for example an improvement or a deterioration in the state of the skin or the hair.

The processor means may be configured to send information to a remote point, e.g. a specific server, said information relating to at least one image acquired by the camera and/or to at least one image selected from the atlas.

In another of its aspects, the invention also provides a method of evaluating a characteristic of body typology, in which use is made of an atlas or of acquisition apparatus as defined above.

In another of its aspects, the invention provides a method of establishing a diagnosis, e.g. a cosmetic diagnosis, the method comprising the following steps:

enabling at least one image in an atlas to be selected from a plurality of images in the atlas expressing different grades of at least one characteristic of body typology, the selected image being considered to correspond to the actual grade of that characteristic with a particular person;

enabling that person to view at least one video sequence associated with the image selected from the atlas, said sequence comprising images that express said characteristic; and

establishing a diagnosis as a function at least of the selection that has been made.

The method may further include the step consisting in using a camera to acquire at least one image of a portion of the person that expresses the characteristic.

When the processor means are remote from the site of examination, the image acquired by the camera may be transmitted to the remote processor means and the diagnosis may also be established remotely.

In another of its aspects, the invention also provides a method of prescribing a substance, for example a cosmetic or a care product, the method comprising the following steps:

enabling at least one image in an atlas to be selected from a plurality of images in the atlas expressing different grades of at least one characteristic of body typology, the selected image being considered to correspond to the actual grade of that characteristic with a particular person;

enabling that person to view at least one video sequence associated with the image selected from the atlas, said sequence comprising images that express said characteristic; and

prescribing a substance, for example a cosmetic or a care product, as a function at least of the selection that has been made.

The method may further include the step consisting in using a camera to acquire at least one image of a portion of the body of the person that expresses the characteristic.

In which case, the image acquired by the camera may be transmitted remotely if the processor means are remote from the site of evaluation, and the prescription of the substance may also be established remotely.

The term “cosmetic” is used to mean a cosmetic product as defined in EEC Council Directive 93/35/EEC of Jun. 14, 1993, amending Directive 76/768/EEC for the sixth time.

More generally, the characteristic of body typology may relate to the state of the hair, in particular the state of the scalp or of the hairs, or the state of the skin, in particular the nature of the skin or its degree of aging.

In another of its aspects, the invention also provides a computer server configured to:

enable at least one image of an atlas comprising a plurality of images corresponding to different grades of at least one characteristic of body typology to be displayed;

enable at least one image to be selected from the atlas; and

enable at least one video sequence to be displayed, the sequence being associated with an image selected from the atlas, said sequence comprising images expressing said characteristic.

The server may be configured to receive an image of a portion of a person that expresses the characteristic to be evaluated, which image may be acquired by means of a camera.

The server may also be configured to send a diagnosis and/or a prescription of treatment and/or information concerning the sale of products relating to the result of the evaluation to an address, e.g. an electronic address.

### BRIEF DESCRIPTION OF THE DRAWINGS

The invention can be better understood on reading the following detailed description of non-limiting implementations, and on examining the accompanying drawings, in which:

FIG. 1 is a diagrammatic perspective view of an example of apparatus made in accordance with the invention;

FIG. 2 shows the FIG. 1 apparatus in use for making a capillary diagnosis;

FIGS. 3 to 6 show various copies of screens displayed while the apparatus is in operation;

FIG. 7 shows a variant embodiment comprising a computer connected via the Internet to a remote server; and

FIG. 8 is a copy of a screen in another variant embodiment of the apparatus.

### MORE DETAILED DESCRIPTION

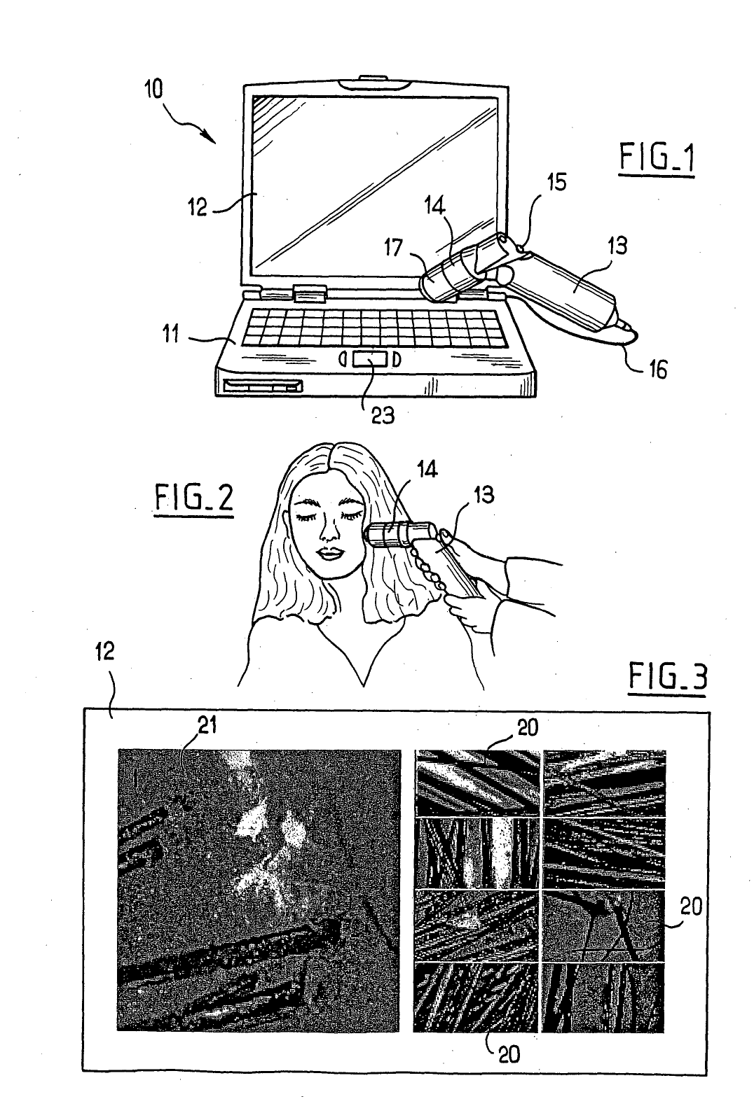

The apparatus 10 shown in FIG. 1 comprises a portable microcomputer 11 having a screen 12 and a hand-held peripheral 13 connected to the microcomputer 11.

The hand-held peripheral 13 includes a camera 14 with integrated lighting and has at least one pushbutton 15 serving, when depressed, to freeze the image being acquired by the camera, as described in greater detail below. The integrated lighting may be a source of white light, ultraviolet light (UV), or infrared light (IR), possibly with an option for selecting a particular type of lighting. The lighting may optionally be polarized. The hand-held peripheral may include, for example, a polarizer placed on the path of the light emitted by a light source and an analyzer placed in front of the camera 14.

The camera 14 may be adapted to acquire an image under one of those types of lighting.

In the example described, the camera 14 is connected by a cable 16 to the microcomputer 11, however it would not go beyond the ambit of the present invention for the hand-held peripheral 13 to be configured to transmit information to the microcomputer 11 over a wireless connection, e.g. a radio connection.

The camera 14 may be provided with a magnifying lens. In the example described, the camera 14 may be provided with a □30 or a □200 magnifying lens depending on whether it is desired to acquire an image of the skin or of the hair.

The microcomputer 11 is configured to display on the screen 12 images 20 of an atlas, these images representing different grades of a characteristic of body typology, for example the state of the scalp, as shown in FIG. 3.

In this example, the atlas has eight images 20 corresponding to different states of the scalp: normal hair, dry hair, greasy hair, dry dandruff, greasy dandruff, hair loss in men, hair loss in women, aging hair.

The microcomputer 11 is configured to display adjacent to the images 20 of the atlas, an image 21 coming from acquisition by the camera. In order to perform this acquisition, the camera 14 is positioned along the hair, as shown in FIG. 2, with the image observed by the camera being displayed in real time (or nearly) on the screen 12. When the operator finds that the image displayed is representative of hair state, the operator presses the pushbutton 15, thus freezing the image 21 displayed on the screen so that the acquisition device 13 can be put down.

The image 21 which is displayed on the screen 12 is a magnified image.

The operator can then select one of the images from the atlas by means of a mouse, for example using a touch-sensitive mouse pad 23 on the microcomputer 11, and then clicking on the selected image.

The microcomputer 11 is configured so as to cause a video sequence to be displayed that is associated with the selected image.

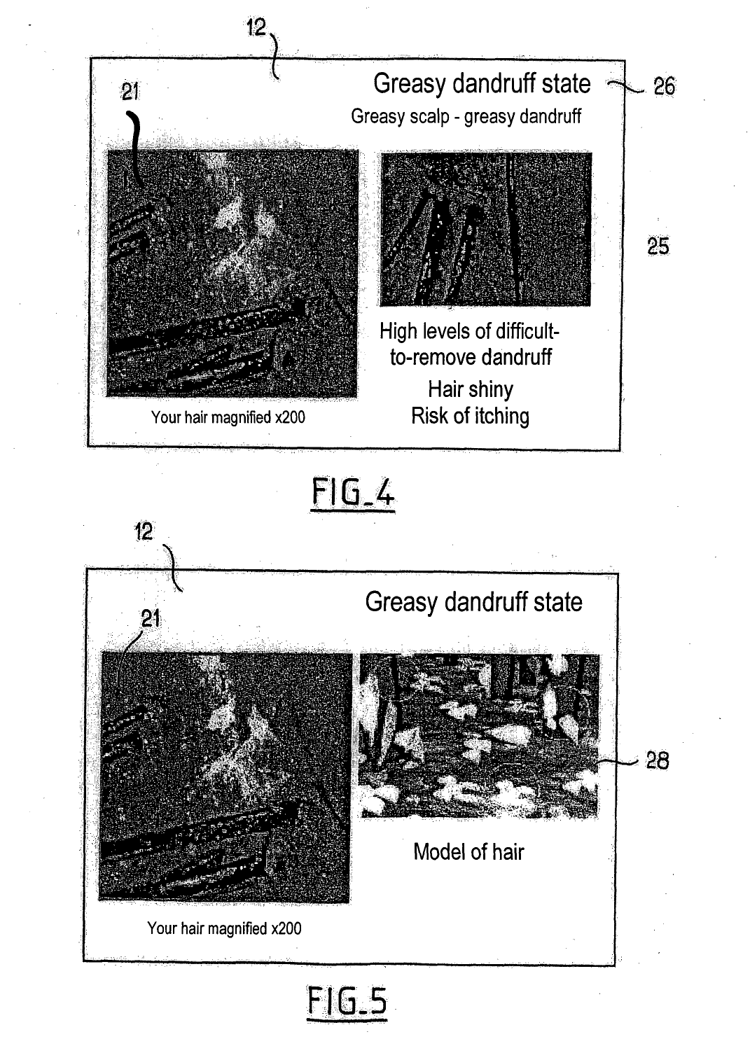

In the example shown, and as can be seen in FIG. 4, the images 20 of the atlas disappear and are replaced by a frame in which the successive images 25 of the sequence are displayed, possibly together with visible commentary 26 in the form of text describing the state corresponding to the selected image.

The image sequence 25 was obtained by filming the scalp of a person whose state is deemed to correspond to that of the image 20 selected from the atlas. Where appropriate, the video sequence is accompanied by an audio sequence, corresponding for example to a sound recording of a person commenting on the images of the video sequence. The duration of the video sequence may be greater than 10 s, for example about 13 s in the example described.

In the example under consideration, the running of the sequence can be interrupted at any time by pressing on a key of the keyboard of the microcomputer 11, for example. It is also possible to stop the sequence on a given image, thus enabling the operator to compare the image 21 under evaluation with the images in the atlas to make sure that the proper image has been selected from the atlas. Freezing also enables the operator who has made the selection to give the person under evaluation additional explanations. Where appropriate, freezing on an image also makes it possible to acquire a new image 21 using the camera 14. Thus, when it is desired to evaluate the state of hair, and when an image is acquired of the roots of the hair, it can be useful to stop the running of the sequence when an image of the tips of the hair appears in the frame for the images of the sequence, and then to proceed with a new acquisition by means of the camera 14 in order to show up similarity or on the contrary in order to reveal difference, and where appropriate select a new image from the atlas.

It will thus be understood that if viewing the sequence gives rise to any doubt in the mind of the operator concerning the pertinence of the original selection, the operator can select another image from the atlas in order to view the sequence that corresponds thereto, and after viewing the sequences associated with various images the operator can decide which corresponds most closely to the state of the person being evaluated.

The sequence of images 25 may be followed, where appropriate, by a display of explanations, for example including drawings 28, as shown in FIG. 5.

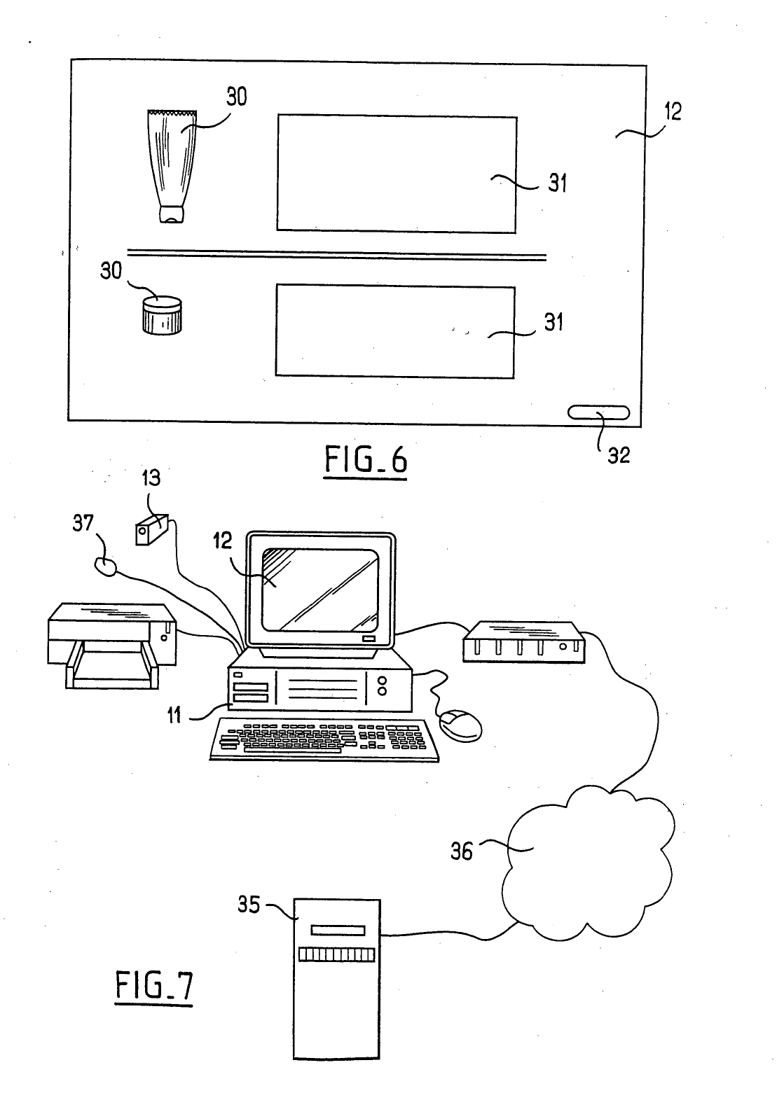

The microcomputer 11 may be configured so that once evaluation has been terminated, it performs a diagnosis and, for example, delivers a prescription, as shown in FIG. 6, with the screen presenting an image 30 of products that can be used to improve the state of the skin or the hair of the person under evaluation, together with corresponding text 31 containing advice and/or dosage. An action button 32 enables a prescription to be printed out by means of a printer (not shown in FIG. 1) can also appear on the screen as shown in FIG. 6.

The apparatus of FIG. 1 can be used, for example, at a point of sale or in a beauty parlor.

In a variant, as shown in FIG. 7, the microcomputer 11, which may comprise a desktop computer, is connected to a server 35 configured to enable images from the atlas to be displayed on the screen 12 of the microcomputer 11. The microcomputer 11 may be connected to a server 35 by a computer network, for example the Internet.

A webcam type camera, possibly provided with a magnifying lens is connected to the microcomputer 11.

It is also possible optionally to connect the microcomputer 11 to peripherals other than a video camera, for example a sensor 37 configured to measure skin color, also known as a melanometer, or other types of sensor, for example an optical or non-optical sensor for measuring relief and/or some mechanical property of the skin or of the hair.

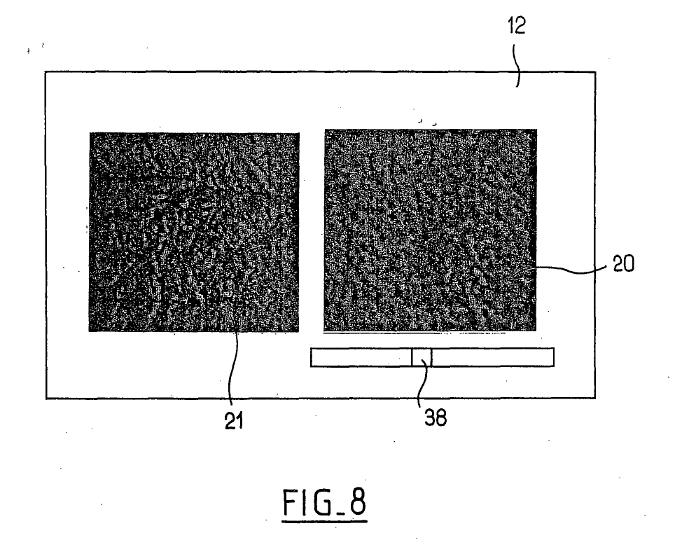

The microcomputer 11 may be configured to display only a single image from the atlas at a time, as shown in FIG. 8.

This figure shows that a single image from the atlas is displayed beside the image 21 acquired by the camera.

In the example under consideration, it is desired to determine the state of the skin, for example its degree of aging. The atlas may comprise a plurality of images associated with respective different degrees of skin aging, and associated with a cursor 38 which enables the particular image that is displayed on the screen to be modified on being moved, for example by means of the computer mouse.

It is thus possible to move the cursor 38, e.g. from left to right, in order to go from young skin to aged skin.

The images 20 of the atlas which are displayed on the screen may be images obtained by means of a camera observing a real skin or they may be images generated by morphing starting from at least two images, corresponding respectively to young skin and to aged skin. By way of example, the images in the atlas may be generated in the manner described in French patent application FR 2 818 529.

Naturally, the invention is not limited to the examples described above.

The images of the atlas may, for example, be hardcopy images, e.g. being printed on a medium, and the images of the sequence may be displayed on the screen of a computer after transmitting information to the computer enabling it to identify which hardcopy image has been selected.

The image displayed on the computer screen coming from the camera need not be juxtaposed with the images from the atlas, although that is less advantageous.

The invention is not limited to evaluating capillary or cutaneous state, and it also applies to evaluating tissue slackening, for example slackening of skin on the neck, or to evaluating wrinkles, sagging, skin firmness, or cellulite.

Throughout the description, and also in the claims, the term “comprising a” should be understood as being synonymous with “comprising at least one” unless specified to the contrary.

What is claimed is:

1. An atlas comprising
a plurality of images corresponding to different grades of at least one characteristic of body typology and
at least one video sequence associated with at least one of the images of the atlas, said sequence comprising images expressing said characteristic.

2. An atlas according to claim 1, wherein the images of the atlas are electronic images suitable for being displayed on a screen.

3. An atlas according to claim 1, wherein all of the images of the atlas are displayed simultaneously on a screen.

4. An atlas according to claim 1, wherein a fraction only of the images of the atlas is displayed simultaneously on a screen.

5. An atlas according to claim 1, wherein at least one image of the atlas is displayed on a screen, and wherein the atlas is configured in such a manner that acting on a cursor enables the displayed image to be replaced by another image of the atlas.

6. An atlas according to claim 5, wherein the images of the atlas are generated by morphing.

7. An atlas according to claim 1, including action buttons associated with the respective images of the atlas and enabling display of the corresponding video sequence to be triggered.

8. An atlas according to claim 1, including at least one audio sequence associated with the video sequence.

9. Image acquisition apparatus, comprising:
at least one camera enabling an image to be acquired;
at least one screen enabling at least one image acquired by the camera to be displayed in association with at least one image of an atlas including images that express different grades of a characteristic of body typology; and
processor means enabling at least one video sequence associated with at least one of the images of the atlas to be displayed on the screen, said sequence comprising images expressing said characteristic.

10. Apparatus according to claim 9, wherein the at least one camera includes a magnifying lens.

11. Apparatus according to claim 10, wherein the lens has a magnification factor greater than or equal to 20 or 160.

12. Apparatus according to claim 9, including at least one pushbutton, and wherein the apparatus is configured to freeze on the at least one screen an image filmed by the camera when said pushbutton is actuated.

13. Apparatus according to claim 9, wherein the processor means comprise a portable microcomputer.

14. Apparatus according to claim 9, wherein the duration of at least one video sequence is greater than or equal to 5 s.

15. Apparatus according to claim 9, including means for enabling an observer to interrupt the running of a video sequence at any time.

16. Apparatus according to claim 15, the apparatus being configured, after the running of a video sequence has been interrupted, to enable a new image to be acquired with the camera, the field of observation of the camera being displayed on the screen simultaneously with the image on which the sequence has been frozen.

17. Apparatus according to claim 9, wherein the camera includes integrated lighting.

18. Apparatus according to claim 17, wherein the lighting can be selected between lighting of the following types: UV, IR, or visible light.

19. Apparatus according to claim 9, wherein the processor means are configured in such a manner that the images of the sequence are displayed at a size that is substantially equal to the size of the image displayed on the screen and coming from the camera.

20. Apparatus according to claim 9, the apparatus being configured in such a manner that the images of the sequence are displayed on the screen in association with an image, coming from the camera.

21. Apparatus according to claim 20, wherein the image coming from the camera is a frozen image.

22. Apparatus according to claim 9, including a sensor suitable for measuring at least one color magnitude.

23. Apparatus according to claim 22, including a melanometer.

24. Apparatus according to claim 9, including a printer.

25. Apparatus according to claim 9, wherein the processor means are configured to establish a diagnosis on the basis of at least one image selected from the atlas.

26. Apparatus according to claim 9, wherein the processor means are configured to send information relating to at least one of at least one image acquired by the camera and at least one image selected from the atlas to a remote point.

27. A method of evaluating a characteristic of body typology in which use is made of an atlas as defined in claim 1.

28. A method of evaluating a characteristic of body typology in which use is made of acquisition apparatus as defined in claim 9.

29. A method of establishing a cosmetic diagnosis comprising the following steps:
enabling at least one image in an atlas to be selected from a plurality of images of the atlas expressing different grades of at least one characteristic of body typology, the selected image being deemed to correspond to the actual grade of that characteristic with a person;
enabling said person to view at least one video sequence associated with the image selected from the atlas, said sequence comprising images expressing said characteristic; and
establishing a diagnosis as a function at least of the selection that has been made.

30. A method according to claim 29, further comprising the steps consisting in using a camera to acquire at least one image of a portion of the body that expresses the characteristic.

31. A method according to claim 30, wherein the image acquired by the camera is transmitted to a remote point, and wherein the diagnosis is established remotely.

32. A method of prescribing a cosmetic, the method comprising the following steps:
enabling at least one image in an atlas to be selected from a plurality of images of the atlas expressing different grades of at least one characteristic of body typology, the selected image being deemed to correspond to the actual grade of that characteristic with a person;
enabling said person to view at least one video sequence associated with the image selected from the atlas, said sequence comprising images expressing said characteristic; and
prescribing a substance, in particular a cosmetic or a care product, as a function at least one of the selection that has been made.

33. A method according to claim 32, further comprising the step consisting in using a camera to acquire at least one image of a part of the person's body that expresses the characteristic.

34. A method according to claim 33, wherein the image acquired by the camera is transmitted to a remote point and wherein the cosmetic is prescribed remotely.

35. A method according to claim 27, wherein the characteristic of body typology relates to the state of the hair.

36. A method according to claim 28, wherein the characteristic of body typology relates to the state of the hair.

37. A method according to claim 27, wherein the characteristic of body typology relates to the state of the skin.

38. A method according to claim 28, wherein the characteristic of body typology relates to the state of the skin.

39. A method according to claim 37 or 38, wherein the characteristic of body typology corresponds to the nature of the skin.

40. A method according to claim 37 or 38, wherein the characteristic of body typology corresponds to the degree of aging of the skin.

41. A method according to claim 35 or 36, wherein the characteristic of body typology corresponds to the state of the scalp.

42. A method according to claim 35 or 36, wherein the characteristic of body typology corresponds to the state of the hairs.

43. A computer server, the server being configured to:
enable at least one image of an atlas comprising a plurality of images corresponding to different grades of at least one characteristic of body typology to be displayed;
enable at least one image to be selected from the atlas; and
enable at least one video sequence associated with an image selected from the atlas to be displayed, said sequence comprising images expressing said characteristic.

44. A server according to claim 43, the server being configured to receive an image of a portion of a person that expresses the characteristic to be evaluated, said image being acquired by a camera.
